(19) United States
(12) Patent Application Publication
(10) Pub. No.: US 2025/0190576 A1
(43) Pub. Date: Jun. 12, 2025

(54) Scanning of Training Code to Prevent Vulnerabilities in Artificial Intelligence (AI) Generated Source Code

(71) Applicant: MICRO FOCUS LLC, Wilmington, DE (US)

(72) Inventors: Douglas Max Grover, Rigby, ID (US); Michael F. Angelo, Houston, TX (US); Alexander Michael Hoole, Vancouver (CA)

(73) Assignee: MICRO FOCUS LLC, Wilmington, DE (US)

(21) Appl. No.: 18/533,713

(22) Filed: Dec. 8, 2023

(51) Int. Cl. G06F 21/57

(52) U.S. Cl. CPC G06F 21/577; G06F 2221/033

(57) ABSTRACT

An initial corpus of source code is received. The initial corpus of source code is for training an Artificial Intelligence (AI) algorithm that generates source code. The initial corpus of source code is scanned, using a test suite, to identify one or more potential vulnerabilities in the initial corpus of the source code. The identified one or more potential vulnerabilities in the initial corpus of the source code are mitigated to produce a training corpus of source code. For example, the mitigation may comprise removing malware from the initial corpus. The mitigation is to remove the vulnerabilities so that the vulnerabilities do not show up in source code generated by the AI algorithm. The AI algorithm is then trained using the training corpus of source code. The trained AI algorithm is executed to produce generated source code.

### FIELD

The disclosure relates generally to software testing and particularly to scanning source code used to train an Artificial Intelligence (AI) algorithm.

### BACKGROUND

One of the advantages of using Artificial Intelligence (AI) is that it can be trained using source code to generate new source code based on a user's input. While this can dramatically decrease the time taken to develop the source code, the generated source code may still have issues.

### SUMMARY

These and other needs are addressed by the various embodiments and configurations of the present disclosure. The present disclosure can provide a number of advantages depending on the particular configuration. These and other advantages will be apparent from the disclosure contained herein.

An initial corpus of source code is received. The initial corpus of source code is for training an Artificial Intelligence (AI) algorithm that generates source code. The initial corpus of source code is scanned, using a test suite, to identify one or more potential vulnerabilities in the initial corpus of the source code. The identified one or more potential vulnerabilities in the initial corpus of the source code are mitigated to produce a training corpus of source code. For example, the mitigation may comprise removing vulnerabilities from the initial corpus. The mitigation, to remove the vulnerabilities, and/or the like, would reduce the likelihood that the vulnerabilities would show up in source code generated by the AI algorithm. The AI algorithm is then trained using the training corpus of source code. The trained AI algorithm is executed to produce generated source code.

The phrases “at least one”, “one or more”, “or,” and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine,” “calculate” and “compute,” and variations thereof, as used herein, are used interchangeably, and include any type of methodology, process, mathematical operation, or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

As described herein and in the claims, the term “test suite” may comprise a product or tool, or a suite thereof, capable of performing a single test, a plurality of tests, a plurality of different tests, and/or the like.

As described herein and in the claims, the terms “vulnerability”/“vulnerabilities” may include any type of software/firmware vulnerability. Someone skilled in the art would also recognize that a “vulnerability” may include any defect that is associated with code of a software program. A defect may be a new defect or a known Common Vulnerabilities and Exposures (CVE). A defect that is intentionally inserted into the code of a software application is considered to be malware, a virus, an insider threat, or the like. A defect that is unintentionally inserted into the code of a software application is considered a weakness or the like. Weaknesses that can be exploited in a given context are considered vulnerabilities and are often represented by a CVE identifier once a patch is available and are publicly known. Additional embodiments extend to prevent both intentional and unintentional defects.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1 is a block diagram of a first illustrative system for scanning an initial corpus to prevent vulnerabilities in AI generated source code.

FIG. 2 is a block diagram of a second illustrative system for scanning an initial corpus to prevent vulnerabilities in AI generated source code.

FIG. 3 is a flow diagram of a process for scanning an initial corpus to prevent vulnerabilities in AI generated source code.

FIG. 4 is a flow diagram of a process for executing an AI algorithm and then scanning the generated source code.

FIG. 5 is a flow diagram of a process rescanning a training corpus when a test suite has been updated.

FIG. 6 is a flow diagram of a process for retraining an AI algorithm based on a change to the initial corpus.

FIG. 7 is a flow diagram of a process for providing feedback based on false positives.

FIG. 8 is a diagram of a graphical user interface for mitigating vulnerabilities in an initial corpus.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

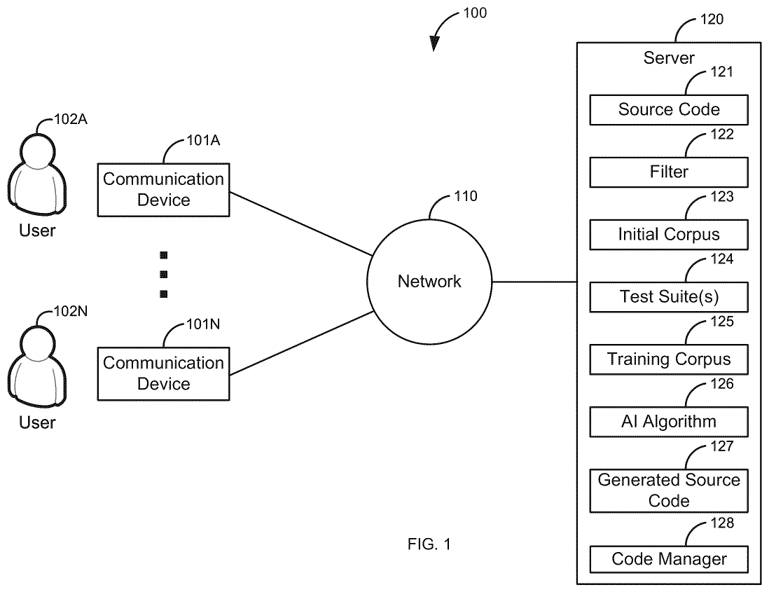

FIG. 1 is a block diagram of a first illustrative system 100 for scanning an initial corpus 123 to prevent vulnerabilities in AI generated source code 127. The first illustrative system comprises communication devices 101A-101N, a network 110, and a server 120. In addition, users 102A-102N are shown for convenience.

The communication devices 101A-101N can be or may include any user device that can communicate on the network 110, such as a Personal Computer (PC), a cellular telephone, a Personal Digital Assistant (PDA), a tablet device, a notebook device, a laptop computer, a smartphone, and the like. As shown in FIG. 1, any number of communication devices 101A-101N may be connected to the network 110, including only a single communication device 101.

The users 102A-102N can be any user 102 of the communication devices 101A-101N. The users 102A-102N access the server 120 via the communication devices 101A-101N.

The network 110 can be or may include any collection of communication equipment that can send and receive electronic communications, such as the Internet, a Wide Area Network (WAN), a Local Area Network (LAN), a packet switched network, a circuit switched network, a cellular network, a combination of these, and the like. The network 110 can use a variety of electronic protocols, such as Ethernet, Internet Protocol (IP), Hyper Text Transfer Protocol (HTTP), Web Real-Time Protocol (Web RTC), and/or the like. Thus, the network 110 is an electronic communication network 110 configured to carry messages via packets and/or circuit switched communications.

The server 120 can be any hardware coupled with software that can manage/host the AI algorithm 126. The server 120 further comprises source code 121, a filter 122, an initial corpus 123, test suite(s) 124, a training corpus 125, the AI algorithm 126, generated source code 127, and a code manager 128. The server 120 may be a host that provides an AI code generation cloud service, a private code generation service, and/or the like. In one embodiment, one or more elements 121-128 of the server 120 (including all of the elements 121-128) may reside on the communication device 101. For example, the source code 121 may reside on the communication device 101 and the elements 122-127 may reside on the server 120.

The source code 121 can be or may include any type of source code 121. The source code 121 may be proprietary source code, open-source source code, third-party source code, and/or the like. The source code 121 may be gathered from various places on the network 110, such as source code repositories, internal repositories, from the communication device(s) 101, from a software development tool, and/or the like. The source code 121 may be in various types of programming languages, such as, Java, JavaScript, Peral, C, C++, C#, Cobol, assembly, and/or the like. The source code 121 may comprise snippets of source code, class libraries, object libraries, object source code, binaries, and/or the like.

The filter 122 can be any software that can be used to filter the source code 121. For example, based on input from a user 102, the filter 122 may filter out any unwanted types of source code 121, such as based on an individual component vulnerability analysis, based on one or more unanalyzed components, based on one or more reverse engineered Common Vulnerabilities and Exposures (CVEs), based on a quality of a software repository, based on a quality of an individual component, based on a software license type, and/or the like.

Once filtered, the source code 121 (or even if not filtered) becomes the initial corpus 123. The initial corpus 123 is a group of source code 121 (e.g., a subset of the source code 121) that is initially going to be used to train the AI algorithm 126. The initial corpus 123 may comprise various source code files. One problem is that the initial corpus 123 may have various vulnerabilities. For example, the initial corpus 123 may have malware, buffer overflow vulnerabilities, password vulnerabilities, weak encryption vulnerabilities, cross-site scripting vulnerabilities, bugs, and/or the like. If the AI algorithm 126 is trained on an initial corpus 123 that has these vulnerabilities, the generated source code 127 will likely include the same vulnerabilities.

The test suite(s) 124 may comprise various tests that identify the vulnerabilities. The test suite(s) 124 may include different types of tests, such as static source code analysis (scanning the source code 121 for vulnerabilities), malware scanning (e.g., virus scanning), dynamic source code analysis (testing the source code 121 while it is active), software composition analysis (e.g., who composed the source code 121), runtime analysis (testing the source code 121 in a real environment), and license analysis (e.g., identifying what open-source license(s) the source code 121 is subject to), and/or the like.

The training corpus 125 is the initial corpus 123 after it has been tested by the test suite(s) 124 and mitigated of some or all of the vulnerabilities. For example, malware may have been removed from the initial corpus 123 to produce the training corpus 125. If there are no vulnerabilities discovered in the initial corpus 123 or if the user 102 decides to not mitigate any vulnerabilities, the initial corpus 123 will be the same as the training corpus 125.

The AI algorithm 126 may be any AI algorithm 126 that can be trained to generate source code 127. The training corpus 125 is used to train the AI algorithm 126.

The generated source code 127 is source code 121 that is generated by the AI algorithm 126. The generated source code 127 may be in various programing languages, such as Java, JavaScript, Peral, C, C++, C#, Cobol, assembly, and/or the like. The generated source code 127 is generated based on input, such as, user input, automated input, and/or the like.

The code manager 128 manages the process of retrieving the source code 121, filtering the source code 121, initiating scanning of the initial corpus 123, training the AI algorithm 126 with the training corpus 125, initiating scanning the generated source code 127, and various aspects of the training, testing, and generation of the generated source code 127. The code manager 128 may receive input from the user 102 during the management process.

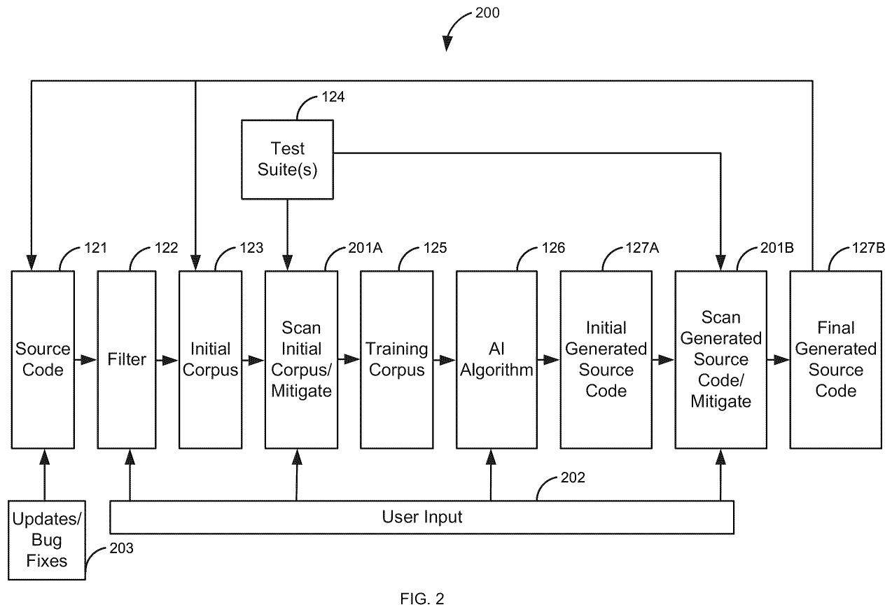

FIG. 2 is a block diagram of a second illustrative system 200 for scanning an initial corpus 123 to prevent vulnerabilities in AI generated source code 127. FIG. 2 shows the interaction between the elements 121-127.

The source code 121 may be periodically updated with the updates/bug fixes 203. For example, the updates/bug fixes 203 may be for a new release of the source code 121. The source code 121 is filtered (e.g., based on the user input 202) to produce the initial corpus 123. The initial corpus 123 is then scanned by the test suite(s) 124 to identify vulnerabilities and then mitigated for vulnerabilities if needed in step 201A to produce the training corpus 125.

The training corpus 125 is used to train the AI algorithm 126. The AI algorithm 126 is executed to generate the initial generated source code 127A. For example, the AI algorithm 126 may generate the initial generated source code 127A based on the user input 202. The initial generated source code 127A is then scanned for vulnerabilities by the test suite(s) 124 and then mitigated if needed in step 201B to produce the final generated source code 127B. The final generated source code 127B may then be used as source code 121 and/or added to the training corpus 125. For example, the final generated source code 127B may be a production application or incorporated as part of the production application.

The user input 202 may be used to as a feedback loop to define what is not wanted in the initial generated source code 127A. For example, if a specific type of vulnerability was previously generated, the user input 202 may be a snippet of source code that is not wanted to be in the initial generated source code 127A.

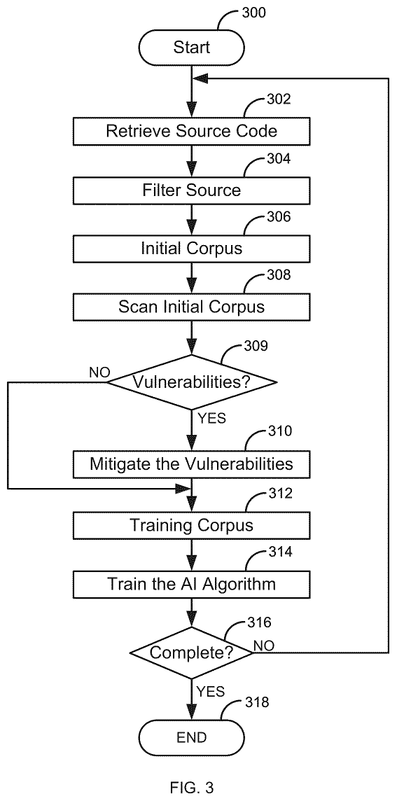

FIG. 3 is a flow diagram of a process for scanning an initial corpus 123 to prevent vulnerabilities in AI generated source code 127. Illustratively, the communication devices 101A-101N, the server 120, the source code 121, the filter 122, the initial corpus 123, the test suite(s) 124, the training corpus 125, the AI algorithm 126, the generated source code 127, and the code manager 128 are stored-program-controlled entities, such as a computer or microprocessor, which performs the method of FIGS. 3-8 and the processes described herein by executing program instructions stored in a computer readable storage medium, such as a memory (i.e., a computer memory, a hard disk, and/or the like). Although the methods described in FIGS. 3-8 are shown in a specific order, one of skill in the art would recognize that the steps in FIGS. 3-8 may be implemented in different orders and/or be implemented in a multi-threaded environment. Moreover, various steps may be omitted or added based on implementation.

The process starts in step 300. The code manager 128 retrieves the source code 121 in step 302. The code manager 128 may retrieve the source code 121 in various ways, such as getting the source code 121 from the server 120, getting the source code 121 from a communication device 101, getting the source code 121 from a repository on the network 110, getting the source code from a development tool, and/or the like.

The code manager 128 may filter the source code 121 in step 304. For example, the user 102 can select which source code 121/directories/snippets are used. The user may be presented with a user interface where the user 102 can select specific source code 121/directories that the AI algorithm 126 will be trained on. The filtering of step 304 produces the initial corpus 123 in step 306. The filtering of step 304 may be accomplished, based on different criteria, such as who authored the source code 121, a quality of the source code 121, a quality of a source of the source code 121, a license associated with the source code 121 (e.g., a type of open-source license), if the source code 121 has known Common Vulnerability Exposures (CVEs), and/or the like. The purpose is to try and produce generated source code 127 that is free of any known vulnerabilities.

The initial corpus 123 is scanned, in step 308, by the test suite(s) 124 to identify any vulnerabilities in the initial corpus 123. If there are not any vulnerabilities in step 309, the process goes to step 312 where the initial corpus 123 becomes the training corpus 125. Otherwise, the code manager 128 mitigates the vulnerabilities in step 310. For example, if the initial corpus 123 has two identified vulnerabilities, the code manager 128 may mitigate zero, one, or two of the vulnerabilities in step 310. The mitigation process may be done automatically based on various criteria, defined vulnerabilities, defined types of malware/viruses, and/or the like. Step 310 may be optional based on the user 102 deciding whether or not to mitigate specific vulnerabilities.

The mitigation process of step 310 produces the training corpus 125 in step 312. The training corpus 125 is used to train the AI algorithm 126 in step 314.

The code manager 128 determines, in step 316, if the process is complete. If the process is not complete in step 316, the process goes back to step 302. Otherwise, if the process is complete in step 316, the process ends in step 318.

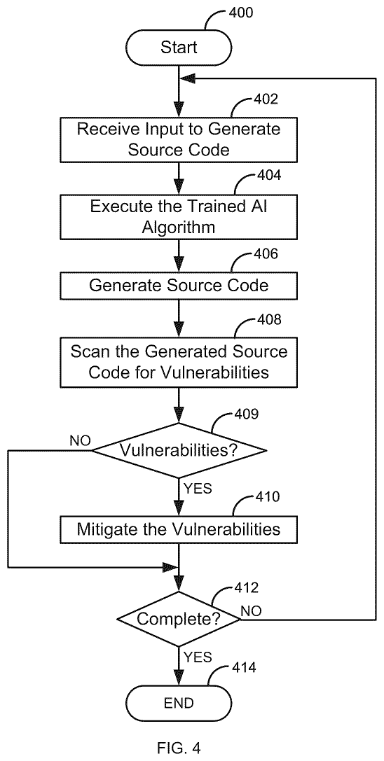

FIG. 4 is a flow diagram of a process for executing an AI algorithm 126 and then scanning the generated source code 127. The process starts in step 400. The code manager 128 receives input, in step 402, to generate the source code (the generated source code 127). The input may be based on user input 201. For example, the user input 201 may be to generate source code 127 for a document management program. In this example, the training corpus 125 may be software that is for different types of document management programs. Step 402 may be executed automatically by the code manager 128. For example, the code manager 128 may have predefined rules for executing the AI algorithm 126.

The code manager 128 executes the trained AI algorithm 126 based on the input, in step 404, to produce the generated source code 127 in step 406. The test suite(s) 124 scans the generated source code 127 for vulnerabilities in step 408. If there are not any vulnerabilities found in step 409, the process goes to step 412. Otherwise, if there are vulnerabilities found in step 408, the vulnerabilities are optionally mitigated in step 410 (e.g., similar to step 310 of FIG. 3). The scanning/mitigating steps 408-410 are useful because the generated source code 127 may generate new vulnerabilities even though the training corpus 125 does not have any known vulnerabilities.

The code manager 128 determines, in step 412, if the process is complete. If the process is not complete in step 412, the process goes back to step 402. Otherwise, if the process is complete in step 412, the process ends in step 414.

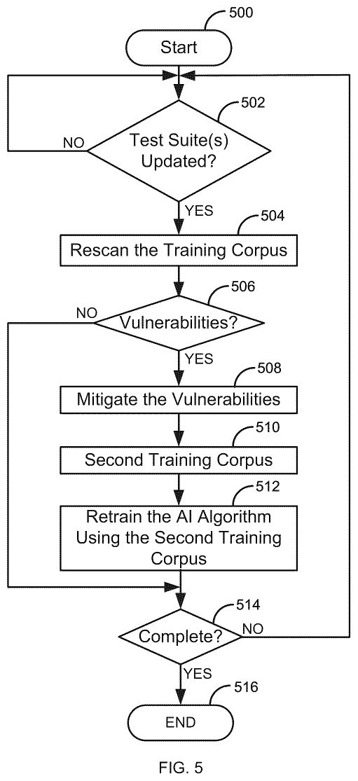

FIG. 5 is a flow diagram of a process rescanning a training corpus 125 when a test suite 124 has been updated. The process starts in step 500. The code manager 128 determines, in step 502, if the test suite(s) 124 has been updated. For example, the test suite 124 may have been updated with new tests that identify new types of vulnerabilities or are able to better detect some of the vulnerabilities. If the test suite(s) 124 have not been updated in step 502, the process of step 502 repeats.

Otherwise, if the test suite(s) 124 have been updated in step 502, the test suite(s) 124 rescans the training corpus 125 (or it could be the initial corpus 123) for new vulnerabilities in step 504. Step 502 may use a change threshold. For example, the change threshold may require five percent of the test suite 124 to be updated, may be based on specific tests being updated, and/or the like. The code manager 128 determines, in step 506, if there are any new vulnerabilities. If there are not any new vulnerabilities in step 506, the process goes to step 514. Otherwise, the vulnerabilities are optionally mitigated in step 508 to produce a second training corpus 125 in step 510. The AI algorithm 126 is retrained, in step 512, using the second training corpus 125.

The code manager 128 determines, in step 514, if the process is complete. If the process is not complete in step 514, the process goes back to step 502. Otherwise, if the process is complete in step 514, the process ends in step 516.

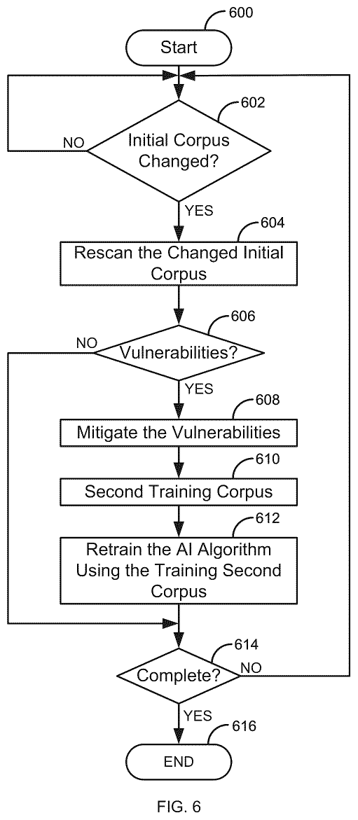

FIG. 6 is a flow diagram of a process for retraining an AI algorithm 126 based on a change to the initial corpus 123. The process starts in step 600. The code manager 128 determines, in step 602, if the initial corpus 123 has changed. If the initial corpus 123 has not changed in step 602, the process of step 602 repeats.

Otherwise, if the initial corpus 123 has changed in step 602, the test suite(s) 124 rescans the training corpus 125 for new vulnerabilities in step 604. Step 602 may use a change threshold. For example, the change threshold may require five percent of the initial corpus 123 to be updated/new/deleted, may be based on specific file types being updated, may require a certain percentage of projects to be impacted by change (added/modified/deleted), and/or the like. The test suite(s) 124 determines, in step 606, if there are any new vulnerabilities. If there are not any new vulnerabilities in step 606, the process goes to step 614. Otherwise, the vulnerabilities are optionally mitigated in step 608 to produce a second training corpus 125 in step 610. The AI algorithm 126 is retrained, in step 612, using the second training corpus 125.

The code manager 128 determines, in step 614, if the process is complete. If the process is not complete in step 614, the process goes back to step 602. Otherwise, if the process is complete in step 614, the process ends in step 616.

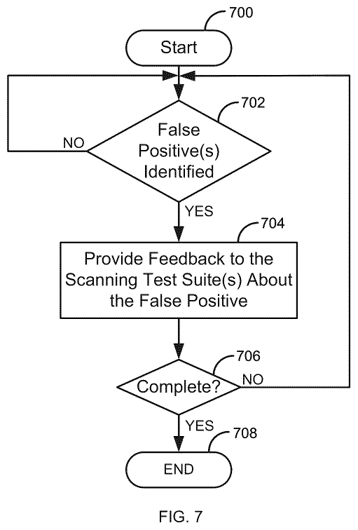

FIG. 7 is a flow diagram of a process for providing feedback based on false positives. The process starts in step 700. The code manager 128 determines, in step 702, if there were any false positives identified in the vulnerabilities (e.g., the vulnerabilities identified by the scan of step 308). A false positive is where a vulnerability is identified but is really not a vulnerability. The false positive may be identified in various ways, such as by the user 102, by an update to the test suite(s) 124, by a bug fix in the source code 121, and/or the like. If a false positive is not identified in step 702, the process of step 702 repeats.

Otherwise, if a false positive is identified in step 704, feedback is provided to the scanning test suite(s) 124. The feedback may be to change a test in the test suite 124, to remove a test in the test suite 124, to add an additional test to the test suite 124, to not filter a particular piece of source code 121, to filter a particular piece of source code 121, and/or the like.

The code manager 128 determines, in step 706, if the process is complete. If the process is not complete in step 706, the process goes back to step 702. Otherwise, if the process is complete in step 706, the process ends in step 708.

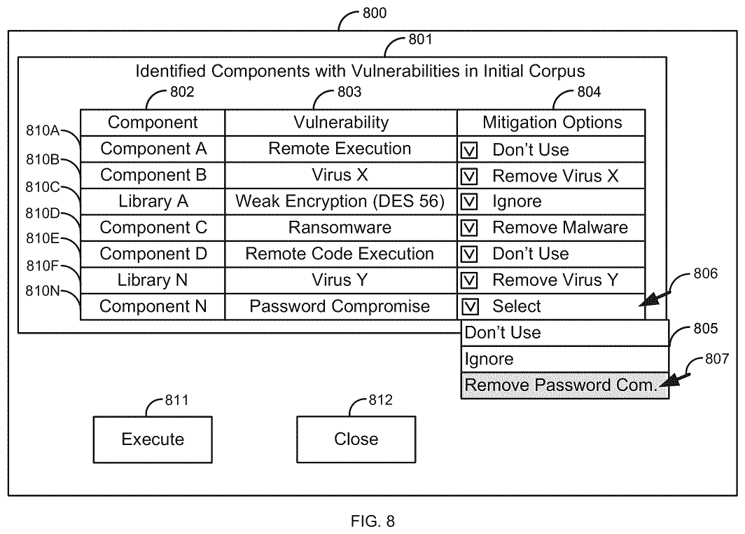

FIG. 8 is a diagram of a graphical user interface 800 for mitigating vulnerabilities in an initial corpus 123. The graphical user interface 800 comprises a vulnerability window 801. The vulnerability window 801 comprises a components column 802, a vulnerability column 803, an options column 804, an options menu 805 and vulnerability rows 810A-810N.

The components column 802 has a list of components. The vulnerability column 803 has the associated vulnerability. The options column 804 allows a user 102 to select a specific type of mitigation for each vulnerability.

When the scan is done on the initial corpus 123 (e.g., as described in step 308), if there are vulnerabilities, the user 102 can display the vulnerability window 801. In FIG. 8, there are seven components (shown in the components column 802) that have vulnerabilities. In the vulnerability row 810A, the component A has a remote execution vulnerability. The user 102 has selected to not use the component A in the training corpus 125. In the vulnerability row 810B, the component B has the virus X. The user 102 has decided to remove the virus X from the initial corpus 123. In the vulnerability row 810C, the library A has a weak encryption (DES 56) vulnerability. The user 102 has decided to ignore the weak encryption vulnerability. For the vulnerability row 810D, the component C has ransomware. The user 102 had selected to remove the ransomware malware. For the vulnerability row 810E, the component D has remote execution code. The user 102 has selected to not use the component D in the training corpus 125. For the vulnerability row 810F, the library N has virus Y. The user 102 has selected to remove the virus Y.

For the vulnerability row 810N, the component N has a password compromise vulnerability. For the vulnerability row 810N, the user 102 has selected, options column 804 (the select menu) in step 806. This displays the options menu 805. The options menu 805 gives the user 102 three options: 1) to not use the component N, 2) to ignore the password compromise vulnerability in the component N, and 3) to remove the password compromise vulnerability from the component N. In FIG. 8, the user 102 is selecting the remove password compromise option (greyed) in step 807.

Once the user 102 has selected the different mitigation options, the user 102 can then select the execute button 811. Once the execute button 811 is clicked, the mitigation options are then implemented (e.g., the virus is removed) and the AI algorithm 126 is trained using the training corpus 125. In this example, the training corpus 125 will not include components A and D and will have the component B (missing virus X), the library A, the component C (without ransomware), the library N (missing virus Y), component N (missing the password compromise source code) and any other components/source code 121 that were part of the initial corpus 123. If the user 102 wants to not do anything, the user 102 can click on the close button 812.

For some types of vulnerabilities there may be different options. For example, if the vulnerability cannot be removed, the option to remove will not be displayed. By removing the vulnerabilities from the initial corpus 123 to produce the training corpus 125, this dramatically reduces the likelihood that the generated source code 127 will have the same vulnerabilities. In addition, there may be elements that are not a vulnerability based on the specific context. For example, some devices may have an initial hardcoded password. In this case, the user 102 can ignore the vulnerability or set up predefined rules for managing different kinds of vulnerabilities.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

Any of the steps, functions, and operations discussed herein can be performed continuously and automatically.

However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, sub combinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A system comprising:
a microprocessor; and
a computer readable medium, coupled with the microprocessor and comprising microprocessor readable and executable instructions that, when executed by the microprocessor, cause the microprocessor to:
retrieve an initial corpus of source code, wherein the initial corpus of source code is for training an Artificial Intelligence (AI) algorithm;
scan the initial corpus of source code, using a test suite, to identify one or more potential vulnerabilities in the initial corpus of the source code;
mitigate the identified one or more potential vulnerabilities in the initial corpus of the source code to produce a first training corpus of source code; and
train the AI algorithm using the first training corpus of source code.

2. The system of claim 1, wherein scanning the initial corpus of source code using the test suite is based on at least one of: static source code analysis, malware scanning, dynamic source code analysis, software composition analysis, runtime analysis, and license analysis.

3. The system of claim 1, wherein the initial corpus of source code is filtered based on at least one of: an individual component vulnerability analysis, one or more unanalyzed components, one or more reverse engineered Common Vulnerabilities and Exposures (CVEs), a quality of a software repository, a quality of an individual component, and a software license type.

4. The system of claim 1, wherein the microprocessor readable and executable instructions further cause the microprocessor to:
execute the trained AI algorithm to produce generated source code.

5. The system of claim 4, wherein the microprocessor readable and executable instructions further cause the microprocessor to:
scan the generated source code to identify one or more new vulnerabilities introduced into the generated source code; and
mitigate the identified one or more new vulnerabilities introduced into the generated source code.

6. The system of claim 1, wherein the microprocessor readable and executable instructions further cause the microprocessor to:
determine that the test suite has been updated; and
in response to determining that the test suite has been updated:
rescan the first training corpus of source code using the updated test suite to identify one or more new potential vulnerabilities in the first training corpus of source code;
mitigate the identified one or more new potential vulnerabilities in the first training corpus of source code to produce a second training corpus of source code; and
retrain the AI algorithm using the second training corpus of source code.

7. The system of claim 6, wherein determining that the test suite has been updated is based on a threshold of changes to the updated test suite.

8. The system of claim 1, wherein the microprocessor readable and executable instructions further cause the microprocessor to:
determine that the initial corpus of source code has changed; and
in response to determining that the initial corpus of source code has changed:
rescan the changed initial corpus of the source code using the test suite to identify one or more new potential vulnerabilities in the changed initial corpus of the source code;
mitigate the identified one or more new potential vulnerabilities in the changed initial corpus of the source code to produce a second training corpus of source code; and
retrain the AI algorithm using the second training corpus of source code.

9. The system of claim 1, wherein the one or more potential vulnerabilities comprise at least one false positive and wherein the microprocessor readable and executable instructions further cause the microprocessor to:
provide feedback to the test suite about the at least one false positive.

10. A method comprising:
retrieving, by a microprocessor, an initial corpus of source code, wherein the initial corpus of source code is for training an Artificial Intelligence (AI) algorithm;
scanning, by the microprocessor, the initial corpus of source code, using a test suite, to identify one or more potential vulnerabilities in the initial corpus of the source code;
mitigating, by the microprocessor, the identified one or more potential vulnerabilities in the initial corpus of the source code to produce a first training corpus of source code; and
training, by the microprocessor, the AI algorithm using the first training corpus of source code.

11. The method of claim 10, wherein scanning the initial corpus of source code using the test suite is based on at least one of: static source code analysis, malware scanning, dynamic source code analysis, software composition analysis, runtime analysis, and license analysis.

12. The method of claim 10, wherein the initial corpus of source code is filtered based on at least one of: an individual component vulnerability analysis, one or more unanalyzed components, one or more reverse engineered Common Vulnerabilities and Exposures (CVEs), a quality of a software repository, a quality of an individual component, and a software license type.

13. The method of claim 10, further comprising:
executing the trained AI algorithm to produce generated source code.

14. The method of claim 13, further comprising:
scanning the generated source code to identify one or more new vulnerabilities introduced into the generated source code; and
mitigating the identified one or more new vulnerabilities introduced into the generated source code.

15. The method of claim 10, further comprising:
determining that the test suite has been updated; and
in response to determining that the test suite has been updated:
rescanning the first training corpus of source code using the updated test suite to identify one or more new potential vulnerabilities in the first training corpus of source code;
mitigating the identified one or more new potential vulnerabilities in the first training corpus of source code to produce a second training corpus of source code; and
retraining the AI algorithm using the second training corpus of source code.

16. The method of claim 15, wherein determining that the test suite has been updated is based on a threshold of changes to the updated test suite.

17. The method of claim 10, further comprising:
determining that the initial corpus of source code has changed; and
in response to determining that the initial corpus of source code has changed:
rescanning the changed initial corpus of the source code using the test suite to identify one or more new potential vulnerabilities in the changed initial corpus of the source code;
mitigating the identified one or more new potential vulnerabilities in the changed initial corpus of the source code to produce a second training corpus of source code; and
retraining the AI algorithm using the second training corpus of source code.

18. The method of claim 10, wherein the one or more potential vulnerabilities comprise at least one false positive and further comprising:
providing feedback to the test suite about the at least one false positive.

19. A non-transient computer readable medium having stored thereon instructions that cause a microprocessor to execute a method, the method comprising instructions to:
retrieve an initial corpus of source code, wherein the initial corpus of source code is for training an Artificial Intelligence (AI) algorithm;
scan the initial corpus of source code, using a test suite, to identify one or more potential vulnerabilities in the initial corpus of the source code;
mitigate the identified one or more potential vulnerabilities in the initial corpus of the source code to produce a first training corpus of source code; and
train the AI algorithm using the first training corpus of source code.

20. The non-transient computer readable medium of claim 19, wherein the instructions further cause microprocessor to:
execute the trained AI algorithm to produce generated source code;
scan the generated source code to identify one or more new vulnerabilities introduced into the generated source code; and
mitigate the identified one or more new vulnerabilities introduced into the generated source code.
